(19) United States
(12) Patent Application Publication
(10) Pub. No.: US 2022/0065234 A1
(43) Pub. Date: Mar. 3, 2022

(54) ION THRUSTER AND METHOD FOR PROVIDING THRUST

(71) Applicants: Nils BRENNING, Johanneshov (SE); Ulf HELMERSSON, Brokind (SE)

(72) Inventors: Nils BRENNING, Johanneshov (SE); Ulf HELMERSSON, Brokind (SE)

(21) Appl. No.: 17/417,148

(22) PCT Filed: Dec. 23, 2019
(86) PCT No.: PCT/SE2019/051340

§ 371 Date: Jun. 22, 2021

(30) Foreign Application Priority Data
Dec. 27, 2018 (SE) 1851669-0

(51) Int. Cl. F03H 1/00

(52) U.S. Cl. CPC F03H 1/0062; F03H 1/0018; F03H 1/0025

(57) ABSTRACT

An ion thruster (1) and a method for providing trust is disclosed. The ion thruster comprises a sputtering magnetron (2), a target (3) arranged at the sputtering magnetron, and a second electrode (4). During a first pulse, the target is at a negative potential (U_{HiP}) with respect to a second electrode and a plasma is sustained whereby atoms are sputtered from the target and at least a portion thereof become ionised by the plasma. During a second pulse, a reversed potential (Uᵣₑᵥ) is applied between the target and the second electrode. This increases the potential of a volume of the plasma adjacent to the target, which in turn accelerates ions in a direction away from the target. Thereby, thrust is provided.

The disclosure further relates to a computer program and a computer readable medium, as well as a spacecraft comprising the ion thruster.

### TECHNICAL FIELD

The present disclosure relates in general to an ion thruster, such as an ion thruster intended for station-keeping or for propulsion of a spacecraft. The present disclosure further relates in general to a method for providing thrust by means of an ion thruster. The present disclosure further relates in general to a computer program, a computer-readable medium and a spacecraft.

### BACKGROUND

When developing a system for propulsion of a spacecraft, it is important to have an efficient use of the propellant mass. In space propulsion, the exhaust speed is a key parameter to achieve a high specific impulse, which in turn is the parameter that determines the efficiency of the use of propellant mass. The higher the speed with which a given amount of propellant mass is expelled, the higher the thrust. In other words, high exhaust speed enables a higher payload-to-propellant mass ratio, a key concept for economic and efficient space propulsion.

Chemical rockets have been used for a long time. However, chemical rockets suffer from a limitation of the exhaust kinetic energies to the order of the chemical binding energies per molecule. This limitation has driven the research towards developing electric propulsion systems.

Ion thrusters use beams of ions to create thrust. One previously known type of ion thruster utilises grids to aid acceleration of ions in order to provide thrust. Another type of ion thruster utilises magnetic fields to aid acceleration of ions. Both gridded and magnetic-field based thrusters to date normally use gaseous propellants. In gridded devices, the grids are used to extract and accelerate the ions. However, thrusters utilising grids suffer from problems in that the grids can become damaged by the ions and the grids reduce the efficiency of the beam due to their limited transparency. Furthermore, the maximum beam current density is limited by the ion space charge in the gap between the first grid, that contains the plasma, and the second grid that accelerates the ions. In devices using magnetic fields, the propellant mass is supplied in the form of a gas and is then passed through a discharge plasma and becomes ionised due to collisions with the plasma electrons. The acceleration is provided by a strong electric field in place, and hence no grids are needed. However, the accelerating electric fields are maintained in the discharge region which often is characterised by instabilities and inhomogeneities. The accelerating potential is therefore not freely or easily changed.

It would be advantageous if an ion thruster capable of using a solid propellant could be provided. A solid propellant could for example significantly reduce the need for constituent components such as gas cylinders, piping systems and mass flow controllers.

RU 2618761 C1 discloses an ion source for low-trust electrostatic rocket engines. The ion source comprises ionic and electron emitters distributed over a source area. Ions are created by redox reactions in the ionic emitter and evaporated into vacuum. The evaporated ions are accelerated by an external electrical field.

US 2010/0264016 A1 discloses a method and apparatus for low pressure high powered magnetron sputtering of a coating to a substrate. A series of high impulse voltage pulses are applied to a target. Sputtering and ionization of the target material is initiated by utilisation of a triggering plasma source positioned proximate to the target which provides a triggering pulse at least partly simultaneously with the target pulse. The document also briefly suggests that said triggered sputtering can be utilised for producing coatings in space, or for space propulsion.

### SUMMARY

The object of the present invention is to enable efficient propulsion of a spacecraft.

The object is achieved by the subject-matter of the appended independent claims.

In accordance with the present disclosure, an ion thruster is provided. The ion thruster comprises a sputtering magnetron providing a magnetic trap zone, and a target constituting a first electrode and being arranged at the sputtering magnetron. The target comprises a first propellant material. The ion thruster further comprises a second electrode arranged in the proximity of the first electrode, a power supply arrangement configured to provide a potential difference between the first electrode and the second electrode, and an electron source device. The electron source device is arranged outside the magnetic trap zone of the sputtering magnetron. The ion thruster further comprises a control device configured to control the power supply arrangement so that, during a first pulse, the first electrode is at a first negative potential with respect to the second electrode, the negative potential being of sufficient amplitude to obtain a spatially averaged current density over a surface of the target that is in contact with the magnetic trap zone, the spatially averaged current density being of sufficient magnitude to sustain a plasma causing sputtering of atoms from the target and ionising at least a portion of the sputtered target atoms. The control device is further configured to control the power supply arrangement so that, during a second pulse (the second pulse following the first pulse), the first electrode is at a second positive potential with respect to the second electrode, thus elevating the potential in a plasma volume adjacent to the target and thereby accelerating ions of sputtered target atoms that leave said plasma volume adjacent to the target, thereby providing thrust.

By means of the above described ion thruster, a solid propellant material may be used to provide thrust to a spacecraft. In essence, the ion thruster causes sputtering of atoms from a target comprising the first propellant and ionises the sputtered target atoms. Thereafter, the ionised sputtered target atoms are electrostatically accelerated by the second pulse and thereby provides thrust. The ion thruster may be operated without addition of process gas, or with an addition of process gas. In case a process gas is used, process gas ions will also be accelerated as a result of the second pulse and therefore also provide thrust. In other words, thrust may be provided by means of further propellants than the first propellant.

By means of the above described ion thruster, the exhaust speeds of the ions (ions of the sputtered target atoms and, where applicable, ions of process gas) can easily be controlled by controlling the potential in the second pulse. More specifically, the ion-accelerating electric potential of the second pulse may be easily and controllably varied up to at least hundreds of volts. Thereby, it is possible to achieve a high exhaust speed, which in turn enables an efficient thrust.

Furthermore, by means of the above described ion thruster, it is possible to achieve a high degree of ionisation, high exhaust speed and a low waste of propellant(s). Therefore, the ion thruster according to the present invention is well suited for providing thrust to a spacecraft.

As mentioned above, the control device of the ion thruster is configured to control the power supply arrangement so that, during the first pulse, the first electrode is at a first negative potential with respect to the second electrode, the first negative potential being of sufficient amplitude to obtain a spatially averaged current density over a surface of the target that is in contact with the magnetic trap. This means that the spatially averaged current density is to be obtained sometime during the first pulse, but not necessarily during the whole pulse as it takes some time to build up the current density at the target. The spatially averaged current density to be obtained during the first pulse may therefore alternatively be denominated as the “maximum” spatially averaged current density.

The spatially averaged current density may be at least 0.5 A/cm². Thereby, it is inter alia achieved that a large portion of the sputtered target atoms becomes ionised. Generally, more than half of the sputtered target atoms will be ionised if the spatially averaged current density is at least 0.5 A/cm². A high degree of ionisation is desired as it increases the efficiency of the ion thruster. The amount of sputtered target atoms that becomes ionised increases with increased spatially averaged current density. Therefore, the spatially current density may preferably be equal to or higher than 2 A/cm², more preferably at least 3 A/cm².

The ion thruster may further comprise a plasma ignition device. The purpose of such a plasma ignition device is to facilitate the ignition of a plasma, especially in case the ion thruster is operated without any addition of process gas or with only a small addition of process gas. In such cases, it may otherwise be difficult to ignite the plasma by means of only the first pulse. The plasma ignition device may for example comprise a cathodic arc source or a laser ablation device, since such devices are well suited for igniting a plasma.

The electron source device may for example comprise a hollow cathode discharge device or a field emission device. Such devices are efficient in providing electrons for the purpose of space charge neutralisation. Furthermore, such devices may be made relatively small and are therefore easy to incorporate into the ion thruster.

The first propellant may be selected from an element having a self-sputtering yield of above 1, or an alloy based on such an element. Thereby, it is possible to operate the ion thruster in a self-sustained self-sputtering mode without any addition of process gas (although process gas may still be added if desired). The first propellant may suitably be selected from the group consisting of Ag, Al, Au, Cr, Cu, Mg, Mn and Zn, or an alloy comprising any one of said elements. These elements have high self-sputtering yields and therefore further facilitates an operation without addition of process gas, if desired.

The ion thruster may further comprise a process gas supply device configured to supply process gas in the vicinity of the target. A supply of process gas in the vicinity of the target minimises an undesirable loss of process gas and therefore improves the efficiency of the ion thruster when the ion thruster is intended to be operated with an addition of process gas.

The control device may be configured to control the power supply arrangement so as to provide a plurality of macro-pulses with a predetermined macro-pulse frequency, each macro-pulse comprising a plurality of consecutive pulse pairs, each pulse pair comprising the first pulse and the second pulse. By means of such macro-pulses, it is possible to supply process gas in connection with the macro-pulses, which in turn minimises undesired loss of process gas. More specifically, the control device may be configured to control the process gas supply device so as to supply process gas in synchronisation with the macro-pulses. Suitably, the control device may be configured to control the process gas supply device so as to supply process gas only during the duration of each macro-pulse of the plurality of macro-pulses. This further minimises loss of process gas.

Alternatively, the control device may be configured to control the process gas supply device in a pulsed mode for the purpose of controlling an active time of discharges in case the control device also controls the power supply arrangement so as to provide a train of pulse pairs, each pulse pair comprising the first pulse and the second pulse. In other words, the control device may control the power supply arrangement so that the first and second pulses are running continuously in the form of pulse pairs, but that there will only be active discharges when a process gas is supplied. This alternative is applicable when there is a need for addition of process gas in order to sustain the plasma. In this case, the addition of process gas by means of the process gas supply device is used for controlling the thrust.

The present disclosure further relates to a method for providing thrust by means of an ion thruster. The ion thruster comprises a sputtering magnetron providing a magnetic trap zone; a target constituting a first electrode and arranged at the sputter magnetron, the target comprising a first propellant material; a second electrode arranged in the proximity of the first electrode; a power supply arrangement configured to provide a potential difference between the first electrode and the second electrode; an electron source arranged outside the magnetic trap zone of the sputtering magnetron; and optionally a process gas supply device configured to supply process gas in the vicinity of the target. The method comprises the steps of:
during a first pulse, applying a negative voltage to the first electrode by means of the power supply arrangement so that the first electrode is at a first negative potential with respect to the second electrode, the negative potential being of sufficient amplitude to obtain a spatially averaged current density (<J_{T}>ₘₐₓ) over a surface (S_{T}) of the target that is in contact with the magnetic trap zone, the spatially averaged current density being of sufficient magnitude to sustain a plasma whereby atoms are sputtered from the target and at least a portion of the sputtered target atoms are ionised in the plasma;
during a second pulse, following the first pulse, applying a positive voltage to the first electrode by means of the power supply arrangement so that the first electrode is at a second positive potential with respect to the second electrode, thereby electrostatically accelerating ions that leave a volume of the plasma adjacent to the target; and supplying electrons by means of the electron source device so as to neutralise the space charge of the accelerated ions.

The method for providing thrust has the advantages described above with regard to the ion thruster. Moreover, the method for providing thrust may be performed by a control device.

In the method for providing thrust, the spatially averaged current density may be at least 0.5 A/cm². Preferably, the spatially averaged current density may be equal to or higher than 2 A/cm², more preferably equal to or higher than 3 A/cm².

The method may further comprise a step of igniting the plasma by means of a plasma ignition device. The plasma ignition device may for example comprise a cathodic arc source or a laser ablation device.

In the method for providing thrust, the first propellant may be selected from an element having a self-sputtering yield (Y_{SS}) above 1, or an alloy based on such an element. In such a case, the sputtering may be performed in a self-sustained self-sputtering mode. Thereby, it is possible to perform the method without any addition of process gas, if desired.

The method may comprise providing a plurality of macro-pulses with a predetermined macro-pulse frequency by means of the power supply arrangement, each macro-pulse comprising a plurality of consecutive pulse pairs, each pulse pair comprising the first pulse and the second pulse. The method may further comprise supplying process gas in the vicinity of the target by means of the process gas supply device in synchronisation with the macro-pulses. Thereby, loss of process gas may be minimised. For example, the method may comprise supplying process gas only during the duration of the macro-pulses.

The method may comprise providing a train of pulse pairs, each pulse pair comprising the first pulse and the second pulse; and controlling the active time of discharges by means of supplying process gas in a pulsed mode by means of the process gas supply device.

The present disclosure further relates to a computer program comprising program code for causing a control device to perform the method for providing thrust as described above.

Moreover, the present disclosure also relates to a computer readable medium comprising instructions which, when executed by a control device, cause the control device to perform the method for providing thrust as described above.

The present disclosure also relates to a spacecraft comprising the ion thruster as described above.

### BRIEF DESCRIPTION OF DRAWINGS

FIG. 1a schematically illustrates a side view of an exemplifying embodiment of an ion thruster in accordance with the present disclosure,

FIG. 1b schematically illustrates a plasma potential profile during the second reversed pulse as a function of the distance Z from the target.

FIG. 2 represents a flow chart schematically illustrating one exemplifying embodiment of the method for providing thrust in accordance with the present disclosure,

FIG. 3 illustrates one example of a pulse pattern that may be used in the ion thruster and the method for providing thrust in accordance with the present disclosure,

FIG. 4 illustrates another example of a pulse pattern (top part) comprising macro-pulses, and process gas inlet flow (bottom part) over time,

FIG. 5 illustrates discharge voltage U_{D}(t) and current I_{D}(t) waveforms recorded during a conventional HiPIMS and a modified HiPIMS comprising a second reversed pulse,

FIG. 6 represents time-integrated ion energy distribution functions (IDEFs) recorded during a conventional HiPIMS (Uᵣₑᵥ=0) and modified HiPIMS (Uᵣₑᵥ=+10 to +70 V) while sputtering a Ti target in Ar at 5 mTorr.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

In the present disclosure, a spacecraft shall be considered to mean a vehicle or device designed for travel or operation outside the earth's inner atmosphere or in an orbit around the earth. Some examples of a spacecraft include (but are not limited to) a satellite, a space shuttle, a rocket, a space station, or a space probe.

In the present disclosure, the term “pulse” shall be considered in its broadest sense and shall therefore be considered to mean something which is temporary, i.e. has a certain duration.

Most of the ion thrusters known to date can be divided into two groups, namely electrostatic ion thrusters and electromagnetic ion thrusters. Electrostatic ion thrusters use the Coulomb force and accelerate the ions in the direction of an electrical field. Electromagnetic ion thrusters use the Lorentz force. The ion thruster described in the present disclosure constitutes an electrostatic ion thruster.

The ion thruster according to the present disclosure comprises a sputtering magnetron and a target arranged at the sputtering magnetron. The sputtering magnetron provides a magnetic field and hence a magnetic trap. A sputtering magnetron is a device that may, when power is applied, generate a plasma with a magnetic electron trap that allows for a high plasma density close to the target. The target may for example be mounted to the sputtering magnetron or to a support in which the sputtering magnetron is arranged. The target acts as a first electrode in the ion thruster. Furthermore, the target comprises a first propellant material. The first propellant material may be a solid first propellant material. The ion thruster further comprises a second electrode arranged in the proximity of the first electrode. By means of the sputtering magnetron, there exists a zone (a volume in space), from which electrons need to cross the magnetic field in order to be able to reach the second electrode. This zone is the magnetic trap. The ion thruster further comprises a power supply arrangement configured to provide a potential difference between the first electrode and the second electrode, and an electron source device. The electron source device is arranged outside the magnetic trap zone of the sputtering magnetron. The ion thruster further comprises a control device configured to control the power supply arrangement so that, during a first pulse, the first electrode is at a first negative potential with respect to the second electrode. The first negative potential is of sufficient amplitude to obtain a spatially averaged current density (<J_{T}>ₘₐₓ) over a surface (S_{T}) of the target that is in contact with the magnetic trap zone, the spatially averaged current density being of sufficient magnitude to sustain a plasma causing sputtering of atoms from the target and ionising at least a portion of the sputtered target atoms. In other words, the negative potential is of sufficient amplitude so that a desired spatially averaged current density (a maximum spatially averaged current density) is reached at some point in time during the first pulse. Said spatially averaged current density that should be obtained (i.e. reached) during the first pulse is preferably at least 0.5 A/cm². The control device is further configured to control the power supply arrangement so that, during a second pulse (herein also sometimes referred to as a reversed pulse), following the first pulse, the first electrode is at a second positive potential with respect to the second electrode, thus elevating the potential in a volume of the plasma adjacent to the target and thereby accelerating ions of sputtered target atoms that leave said volume adjacent to the target, thereby providing thrust.

The ion thruster described above may be operated with further propellants, in addition to the first propellant. A second propellant may for example be in the form of a process gas, as will explained in more detail below. When operating the ion thruster with a process gas, such a process gas will not only act as a propellant but may also serve the purpose of sustaining the plasma.

Depending on the selection of the first propellant material, the ion thruster may be operated without any addition of process gas to sustain the plasma, or with only a small addition of process gas as will be described in more detail below. Thus, the ion thruster may comprise fewer or smaller gas cylinders in case where there is still a need for process gas, or even be free of such gas cylinders when there is no need for addition of process gas.

The method for providing thrust by means of an ion thruster, such as the ion thruster described above, comprises a step of, during a first pulse, applying a negative voltage to the first electrode by means of the power supply arrangement so that the first electrode is at a first negative potential with respect to the second electrode. The negative potential is of sufficient amplitude to sustain a plasma whereby atoms are sputtered from the target and at least a portion of the sputtered target atoms are ionised in the plasma. More specifically, the negative potential is of sufficient amplitude to obtain a desired spatially averaged current density (a maximum spatially averaged current density) over the part of the target surface that is in contact with the magnetic trap zone during the first pulse. Said desired spatially averaged current density is in turn of sufficient magnitude to sustain the plasma, whereby atoms are sputtered from the target and at least a portion of the sputtered target atoms are ionised in the plasma.

The method further comprises a step of, during a second pulse following the first pulse, applying a positive voltage to the first electrode by means of the power supply arrangement so that the first electrode is at a second positive potential with respect to the second electrode. By means of the second pulse, ions of sputtered target atoms that leave a volume of the plasma adjacent to the target are electrostatically accelerated. Furthermore, the method comprises a step of supplying electrons by means of the electron source device so as to neutralise the space charge of the accelerated ions. The above described method may be performed by a control device.

The method may further comprises a step of supplying a process gas in the vicinity of the target. This may be achieved by means of a process gas supply device. In case a process gas is supplied in the vicinity of the target, ions of the process gas will be created in the plasma. Ions of the process gas that leave the plasma volume adjacent the target will also be electrostatically accelerated by means of the second pulse, and will thus provide thrust.

The ion thruster and the method of providing thrust in accordance with the present disclosure are based on the technique of High Power Impulse Magnetron Sputtering (HiPIMS), which is a method for physical vapour deposition of thin films. HiPIMS is a development of the dc Magnetron Sputtering (dcMS) technique used for the same purpose. In HiPIMS, short high-power pulses are applied to the sputter target. The current densities can be up to several A/cm². The pulse repetition frequency is kept low in order to avoid target damage caused by overheating. A typical duty cycle, i.e. the time the power is on compared to the total time, may be only a few %. Compared to dcMS, the high plasma density during the pulses gives a much larger fraction of ionization of the sputtered material, and also enhances the ion energies in the flux to the substrate to be coated.

However, in contrast to the conventional HiPIMS technique, the ion thruster and the method for providing thrust according to the present disclosure also utilizes a second pulse of reversed polarity, following the first pulse with negative polarity of the target as used in conventional HiPIMS. More specifically, during a first (conventional HiPIMS) pulse, a discharge is ignited creating a dense plasma in front of the target. The plasma causes sputtering of atoms from the target. Furthermore, the sputtered target atoms become ionised in the plasma, creating a large fraction of ions. During a second pulse, the target has a reversed polarity and the discharge dies out while a volume of the plasma, adjacent the target, acquires close to the same potential as the target. Outside this volume of the plasma, adjacent the target, the potential does not become elevated by the application of the second pulse. Ions (i.e. ions of sputtered target atoms and, when a process gas is used, also ions of the process gas) which, in a direction away from the target, leave the volume of the plasma having an elevated potential (i.e. the volume of the plasma adjacent the target) become electrostatically accelerated by the potential difference between the different plasma volumes, thereby providing thrust. The thrust provided is dependent on the potential of the second reversed pulse and increases with the amplitude of the second pulse. A reversed discharge during the second pulse is undesirable as it may risk reducing the efficiency of the ion thruster and/or damage constituent components thereof. However, due to the magnetic topology of magnetrons, the potential of the reversed second pulse can be quite high without risking ignition of an undesirable reversed discharge. This in turn enables high ion beam energies.

In contrast to a conventional HiPIMS device, the ion thruster does not comprise a substrate on which the sputtered material is collected. Instead, the ionized sputtered target atoms are allowed to escape freely in the direction away from the target.

Furthermore, since the electrons produced in the discharge are trapped by the magnetic field of the sputtering magnetron, the ion thruster comprises a separate source of electrons, outside the magnetic trap, for space charge neutralization. The source of electrons is in the form of an electron source device. By way of example, the electron source device may comprise or constitute a hollow cathode discharge device or a field emission device.

It is previously known that in a conventional HiPIMS process, ions of the target material may be attracted back to the target and sputter out new atoms. This is sometimes referred to as self-sputter recycling. Ions of the target material that return to the target will sputter out new target atoms with a probability given by the self-sputter yield, Y. These sputtered target atoms can then in turn become ionized in the plasma, drawn back to the target, and sputter once more. A positive feedback loop called self-sputter recycling is thus closed. Recycled target ions can, for materials with high enough self-sputter yield, contribute with a large fraction of the total discharge current at the target surface. By way of example, in US 2010/0264016 A1 referenced above, an example is given in which a copper target is sputtered in HiPIMS and enters a discharge mode called self-sustained self-sputtering after the plasma has been triggered by a miniature plasma source. Thereby, a process gas is not needed in order to sustain the plasma.

In case a process gas is used, a recycling loop of process gas ions is also possible. The process gas ions that hit the target and sputter out target material will either be reflected at once at the target surface, or become embedded in the target. In the latter case, they will most likely be released during the intense bombardment during a later pulse. In either case, they will likely leave in neutral form, and enter the dense plasma in front of the target. If the plasma density is high enough, the returning process gas atoms have a large probability to be ionized once again, become drawn back to the target, and once more return to the plasma volume in neutralized form. This closes a process gas recycling loop. The process gas recycling loop runs in parallel with the self-sputter recycling loop described above.

The processes of self-sputter recycling and process gas recycling in conventional HiPIMS discharges were combined in Brenning et al, “A unified treatment of self-sputtering, process gas recycling, and runaway for high power impulse sputtering magnetrons”, Plasma Sources Sci. Technol. 26 (2017) 125003, into a generalised recycling model. Ion recycling, i.e. the sum of self-sputter recycling and process-gas recycling, was shown to carry more than half of the current when the discharge current density J_{D} to the target was approximately in the range J_{D}>1 A/cm².

The ion back-attraction effect may be beneficial to space propulsion. The back-attraction of ions of the target material to the target does not present a loss since the target is an actual reservoir of the first propellant. If the self-sputter yield is above 1, this back-attraction results in an increase of sputtered material that can contribute to the thrust after ionisation and acceleration. Also the back-attraction of ions of the process gas is beneficial. When process gas ions are recycled, they can contribute to the sputtering several times before they leave in the exhaust. This reduces the amount of process gas needed for a given amount of target material to become sputtered.

Since neutrals are not accelerated by electrical fields, they leave the ion thruster at the (inherent) low thermal speeds or at the somewhat higher speeds of the sputtered atoms. For efficient space propulsion, a high degree of ionisation is therefore important. It is previously known that conventional HiPIMS enables a high degree of ionisation by control of the amplitude of the negative pulses to the target as well as their time duration. This knowledge may thus be used for the optimisation of the degree of ionisation of sputtered target atoms in the ion thruster according to the present disclosure.

The efficiency of the ion thruster may be increased by (i) minimising the number of ions that are not accelerated by the second pulse, (ii) maximising the energy (or specifically the speed) of the accelerated ionised sputtered target atoms as well as ionised process gas (when a process gas is used), and (iii) minimising the loss of sputtered target atoms (i.e. the first propellant) as well as process gas (the process gas also acting as a second propellant). Examples of how to achieve this include, but are not limited to, the following four aspects. Firstly, the pulse power may be increased and thereby the plasma density in front of the target. This has the effect of increasing the probabilities of ionization both of the sputtered target atoms and of the process gas, and also enhances the process gas recycling efficiency. Secondly, the amplitude of the reversed second pulse may be increased. This has the effect of increasing the acceleration of the ions and thus the speed of the ions in the exhaust. Thirdly, a target material (first propellant) with low atomic mass may be selected. This also increases the speed of the ions in the exhaust for a given potential of the second pulse. Fourthly, the length of the first (conventional HiPIMS) pulse may be minimised. This has the effect to reduce the fraction of the ions in the exhaust that leave the thruster during the first pulse and therefore are not accelerated by the second pulse.

It should be recognised that although it is general is desired that as much of the ions as possible is accelerated in order to provide the desired thrust, it may also in some cases be advantageous to allow a portion of the ions to remain in the ion thruster for the purpose of facilitating ignition of the discharge during a following first pulse.

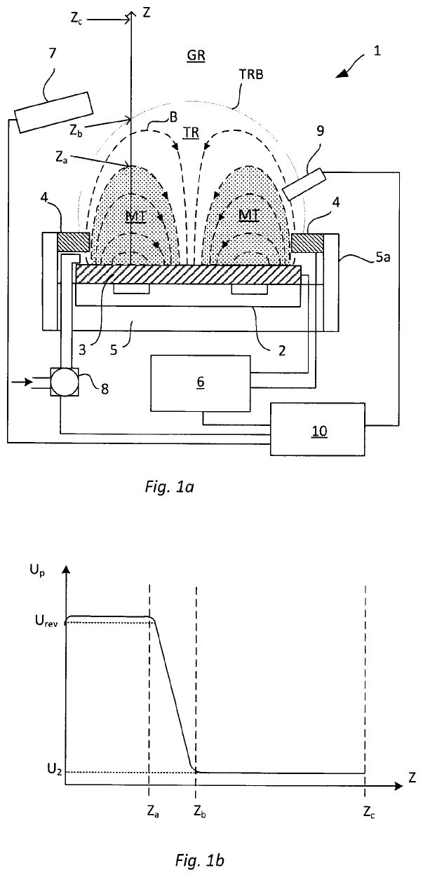

FIG. 1a schematically illustrates a side view of an exemplifying embodiment of an ion thruster in accordance with the present disclosure. The ion thruster 1 comprises a sputtering magnetron 2. The sputtering magnetron 2 has a magnetic field, illustrated by dashed lines corresponding to magnetic field lines B, which provides a magnetic trap zone MT. The sputtering magnetron 2 may be arranged in a support 5 as illustrated in the figure. It is also possible to mount the sputtering magnetron 2 on top of a support, if desired.

The ion thruster 1 further comprises a target 3 arranged at the sputtering magnetron 2. For example, the target 3 may be mounted to the support 5 in which the sputtering magnetron 2 is arranged as shown in the figure. Alternatively, the target may for example be arranged on the sputtering magnetron. The arrangement of the target in relation to the sputtering magnetron means that the magnetic trap zone MT extends in front of the target (upwards in the figure). Outside the magnetic trap zone MT, there is a transition region TR defined by a transition region boundary TRB. Outside of the transition region TR, there is a locally grounded region GR. Herein, GR denotes a region from which the magnetic field lines are not, in any direction, in contact with the target. Here, the term “contact” is intended to mean that the magnetic field lines directly intersect the target surface (without, for example, first intersecting and going through the second electrode), as illustrated in FIG. 1a. During operation of the ion thruster 1, the plasma will be present in MT, TR as well as GR.

The target 3 will during operation of the ion thruster act as a first electrode. The target may for example be circular, but is not limited thereto. Furthermore, although the target is illustrated in the figure as being planar, it shall be recognised that it is not limited thereto. The target 3 comprises or consists of a first propellant material, i.e. a material from which the propulsion provided by means of the ion thruster may be effectuated.

The ion thruster further comprises a second electrode 4 arranged in the proximity of the target 3. The second electrode 4 may for example have the physical shape of a circular ring, but is not limited thereto. The second electrode 4 may for example be mounted to the support 5 by means of support arms 5a as shown in the figure, or a cylinder sitting around the magnetron and the target. Although the first and the second electrodes may be mounted to the same support, the second electrode 4 is electrically isolated from the target 3 in order to avoid any short-circuit there between. This could for example be achieved by an isolator (not shown) arranged between the target 3 and the support 5.

The ion thruster 1 further comprises a power supply arrangement 6. As shown in the figure, the power supply arrangement is connected to the target 3 as well as the second electrode 4. The power supply arrangement 6 is configured to provide a potential difference between the target 3 and the second electrode 4, when desired.

The ion thruster 1 also comprises a control device 10 configured to control the power supply arrangement 6. More specifically, the control device 10 is configured to control the power supply arrangement such as to provide the intended potential difference between the target 3 and the second electrode 4 during the first pulse as well as the second pulse. The control device 10 is further configured to control the power supply arrangement so as to provide the intended duration and frequency of the first pulse and the second pulse, respectively. The first and second pulses are repeated, in the form of a pulse pair, as long as there is a desire to provide thrust.

During the first pulse, a negative voltage is applied to the target 3 with respect to the second electrode 4 by means of the power supply arrangement 6. Thereby, a discharge is ignited which in turn creates a dense plasma in front of the target 3. During the first pulse, atoms are sputtered from the target 3 by means of the plasma and become ionised in the plasma. This is achieved by selecting a negative voltage of appropriate amplitude.

During the second pulse, following the first pulse, the target 3 has a reversed polarity (compared to the first pulse) and the discharge dies out. At the same time, a volume of the plasma in front of the target acquires close to the same potential as the target. The ions which leave this volume in a direction away from the target therefore become electrostatically accelerated away from the target by the potential applied in the second pulse. Thereby, the accelerated ions provide thrust. The ions are accelerated to an energy that increases with the potential of the second pulse. Due to the magnetic topology of sputtering magnetrons, the potential of the reversed second pulse can be quite high without igniting an undesirable reversed discharge. This enables high ion beam energies, which in turn provides efficient thrust.

The ion thruster 1 further comprises a separate source of electrons in order to neutralise the space charge of the accelerated ions in the exhaust. This is achieved by means of an electron source device 7 arranged outside of the magnetic trap zone MT. The electron source device 7 may for example be a hollow cathode discharge device or a field emission device. The electron source 7 may be arranged so as to at least partly be in contact with the created plasma during the operation of the ion thruster. The control device 10 may be configured to also control the operation of the electron source device 7.

The ion thruster 1 may optionally further comprise a process gas supply device 8 if desired. The process gas supply device 8 may be configured to supply process gas in the vicinity of the target 3, preferably as close to the target as possible. Said process gas supply device 8 may however be omitted in case a first propellant material with self-sputtering yield above 1 is used. When a process gas is supplied, it may act as a second propellant. In other words, the propulsion would in such a case be effectuated by means of both the first propellant and the second propellant.

The ion thruster 1 may optionally further comprise a plasma ignition device 9. The control device 10 may be configured to control the operation of the plasma ignition device 9. The plasma ignition device is configured to assist in the ignition of a plasma, in particular in case where no process gas is supplied in the vicinity of the target 3. More specifically, the plasma ignition device may be configured to generate a plasma plume proximate to the target 3 to thereby initiate a discharge between the first electrode and the second electrode. This is performed during a first pulse. It should be recognised that in most cases there will be a remaining plasma, after a pulse pair, which is sufficient to re-start the discharge in the first pulse of a subsequent pulse pair. Therefore, the plasma ignition device may in many cases only need to be operated in the beginning of discharge operation, i. e. at the start of a sequence of pulse pairs. Once the plasma has been ignited, the plasma ignition device 9 may be switched off. The plasma ignition device 9, may however be operated in conjunction with any first pulse, if desired. During the second pulse, the plasma ignition device is not operated. The plasma ignition device 9 may for example comprise a cathodic arc source or a laser ablation device.

The plasma ignition device 9 as well as the electron source device 7 can be made quite small and therefore does not add unnecessary space to the ion thruster.

It shall be recognised that the electron source device 7 and/or the plasma ignition device 9 may be connected to the power supply arrangement such that the power supply arrangement may provide the power necessary for the operation of the electron source device and/or the plasma ignition device, although this is not illustrated in the figure. However, it is also possible to include other means for providing the power needed for their operation, if desired.

FIG. 1b schematically illustrates a plasma potential profile during the second reversed pulse as a function of the distance Z from the target. The distance Z from the target is illustrated by the arrow Z in FIG. 1a. The distances Zₐ, Z_{b} and Z_{c} shown in FIG. 1b are also shown in FIG. 1a. Distance Zₐ corresponds to the boundary of the magnetic trap zone MT. Distance Z_{b} corresponds to the transition region boundary TRB. Distance Z_{c} is intended to correspond to the outer part of the plasma. As shown in FIG. 1b, a volume of the plasma adjacent the target will have a higher plasma potential Uₚ than a volume of the plasma further away from the target. It is this difference in the potential of the different volumes of the plasma which causes the acceleration of the ions, thereby providing the desired thrust. The variable U₂ in the figure is the potential of the second electrode.

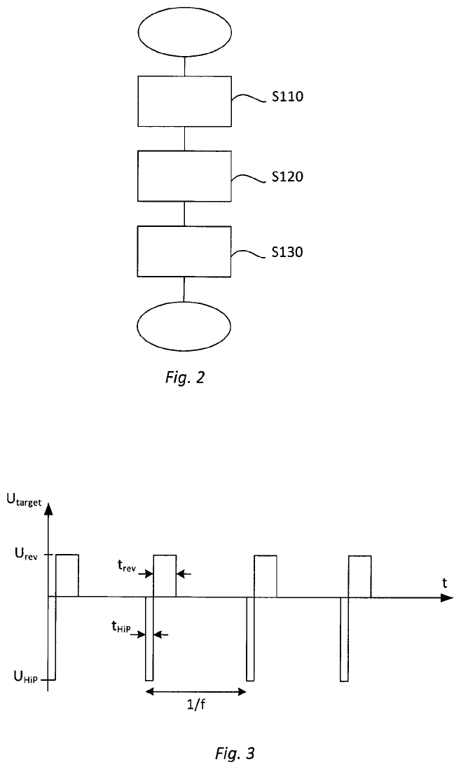

FIG. 2 represents a flow chart schematically illustrating one exemplifying embodiment of the method for providing thrust in accordance with the present disclosure. The method comprises a step S110 of, during a first pulse, applying a negative voltage to the first electrode by means of the power supply arrangement so that the first electrode is at a first negative potential with respect to the second electrode. The negative potential is of sufficient amplitude to obtain a spatially averaged current density (<J_{T}>ₘₐₓ) over a surface (S_{T}) of the target that is in contact with the magnetic trap zone. The spatially averaged current density is of sufficient magnitude to sustain a plasma whereby atoms are sputtered from the target and at least a portion of the sputtered target atoms are ionised in the plasma. The method then comprises a step S120 of, during a second pulse, applying a positive voltage to the first electrode by means of the power supply arrangement so that the first electrode is at a second positive potential with respect to the second electrode, thereby electrostatically accelerating ions that leave a volume of the plasma, said volume of the plasma being adjacent to the target. The method further comprises a step S130 of supplying electrons by means of the electron source device so as to neutralise the space charge of the accelerated ions in the exhaust. The step S130 may be performed in parallel, i.e. simultaneously in time, with each of the steps S110 and S120. The steps of the method may be repeated as long as there is a desire to provide thrust. Furthermore, the step S130 may be performed continuously, i.e. without any interruption in time, as long as there is a desire to provide thrust.

FIG. 3 illustrates one example of a pulse pattern, which may be used in the ion thruster and the method according to the present disclosure. In the figure the potential of the target U_{target} (i.e. the first electrode) with reference to the second electrode is shown over time t. The pulse pattern is defined by five different parameters, namely: the potential of the first pulse, U_{HiP}; the duration of the first pulse, t_{HiP}; the potential of the second pulse, Uᵣₑᵥ; the duration of the second pulse, tᵣₑᵥ; and the frequency, f. As shown in the figure, the second pulse may immediately follow the first pulse. The first and the second pulses may be described as forming a pulse pair. As shown in the figure, there may also be a duration wherein no pulse is applied. The frequency f is given by the duration between the starts of two consecutive first pulses.

It shall be recognised that FIG. 3 merely illustrates one example of a pulse pattern. The pulse pattern shown in the figure may be modified for example by the first and second pulses being separated in time by a delay in time before initiation of the second pulse after the termination of the first pulse. Additionally or alternatively, the pulse pattern may be modified by allowing the second pulse to extend in time until the initiation of a subsequent first pulse. In other word, there need not be a duration wherein no pulse is applied between a second pulse with potential Uᵣₑᵥ and a following first pulse with potential U_{HiP}. Furthermore, the pulse pattern may be modified by for example including a third pulse with a third potential, such as a third pulse with a positive potential U₃ following the second pulse.

As discussed above, the efficiency of the ion thruster is dependent of three criteria, namely (i) minimizing the number of not accelerated ions, (ii) maximising the speed of the accelerated ions, and (iii) minimizing the loss of atoms in not ionized (neutral) form. It is desirable to get into a high power regime during the first pulse, specifically high peak current density J_{Tmax} at the target. It is previously known that conventional HiPIMS enables a control of the peak current density through control of the potential U_{HiP} of the negative pulses to the target as well as the pulse length t_{HiP} of the first pulse. A high peak current density is desired for several reasons: more efficient ion recycling keeps ions in the magnetic trap during the first pulse, a higher plasma density may give more doubly charged ions, and a high degree of ionization in the exhaust may be achieved. Furthermore, the duration of the first pulse, t_{HiP}, should suitably be as short as possible while still achieving the desired J_{Tmax}. Short t_{HiP} are desirable since this minimizes the loss of not-accelerated ions that leave in the exhaust direction during the first pulse. Moreover, the potential of the second pulse, Uᵣₑᵥ, should be as high as possible and the duration of the second pulse, tᵣₑᵥ, long enough to accelerate as many as desired of the ions that were in the plasma reservoir at the end of the first pulse.

It shall be recognised that the current density J_{T} at the target is generally not constant over the whole surface thereof. That is, the current density may vary at different locations of the surface of the target. Therefore, it may in practice be more appropriate to discuss the spatially averaged current density <J_{T}>, instead of J_{T}. The spatially averaged current density is given by <J_{T}>=I_{D}/S_{T}, wherein I_{D} constitutes the discharge current and S_{T} constitutes the area of the part of the target surface which is in contact with the magnetic trap zone. Furthermore, the current density J_{T} inherently varies over the duration of the first pulse as it takes some time to build up the current density. Therefore, it is appropriate to discuss the highest (i.e. maximum) spatially averaged current density <J_{T}>ₘₐₓ obtained at any point in time during the first pulse. This will in practice be reached at or close to the end of the first pulse. The parameters of U_{HiP} and t_{HiP} of the first pulse should be chosen such that the maximum spatially averaged current density <J_{T}>ₘₐₓ is at least equal to or higher than 0.5 A/cm². <J_{T}>ₘₐₓ may be up to 5 A/cm², or even higher. Preferably, <J_{T}>ₘₐₓ is equal to or higher than 2 A/cm², more preferably equal to or higher than 3 A/cm².

The potential U_{HiP} in the first pulse may typically be between about −400 V and about −1500 V (including the end values of the range), but may also be higher or lower than the specified range. The duration of first pulse, t_{HiP}, may typically be at least about 5 μs and up to about 50 μs. The potential of the second pulse, Uᵣₑᵥ, may typically be at least about 300 V. In essence, there is no upper limit to the potential of the second pulse as long as there is no electric breakdown during the second pulse between the first electrode and the second electrode. The duration of the second pulse, tᵣₑᵥ, may typically be at least about 50 μs and up to about 500 μs. The frequency, f, should be below the limit where the target may risk becoming damaged by overheating and therefore inter alia depends on the ability to cool the target. The frequency, f, may be determined by experimental tests based on the configuration and the expected environmental conditions of the ion thruster during use thereof.

The ion thruster according to the present disclosure may be operated with an addition of process gas, or without an addition of process gas. The decisive factor as regard whether a process gas is needed or not is primarily the selection of the first propellant material of the target. Furthermore, discharges which need a supply of process gas can be more or less dependent of the amount of process gas needed. More specifically, the key parameter as regards the need for supply of process gas is the self-sputtering yield Y_{SS} of the target material. The self-sputtering yield is the ratio between the number of sputtered target atoms and the number of incident ions of the same species as the target material. The self-sputtering yield depends not only on the material but also on the energy of the incident ions. An increase in the energy of the incident ions increases the self-sputtering yield. The incident ion energy can be controlled by the applied amplitude U_{HiP} of the first pulse.

In general, the need for ions of a process gas in the sputtering process decreases with an increase of the self-sputtering yield Y_{SS}. In case of the target comprising a material with a self-sputtering yield Y_{SS} above 1 at the ion energy obtained by the applied amplitude U_{HiP} of the first pulse, supply of process gas can be omitted while still enabling sputtering. The alternatives of supply of process gas and no supply of process gas will be discussed further below.

In case the propellant of the target does not have a self-sputter yield of >1, a process gas is needed in order to sustain the plasma so as to sputter target atoms. Depending on the pressure achieved in the volume in front of the target by the addition of process gas, the plasma may be ignited automatically in the first pulse. However, in case only a small addition of process gas is made, for example to a pressure in the order of 10⁻⁴ to 10⁻⁵ Torr, it may be needed to ignite the plasma by means of a plasma ignition device. The plasma ignition device may for example provide a triggering plasma plume directed towards the target or generated at the target. The operation of the plasma ignition device is suitably synchronised with the start of the discharge, for example by initiation of the triggering plasma plume immediately before the first pulse or during the first pulse in the sequence of repeated pulse pairs during the time thrust is desired.

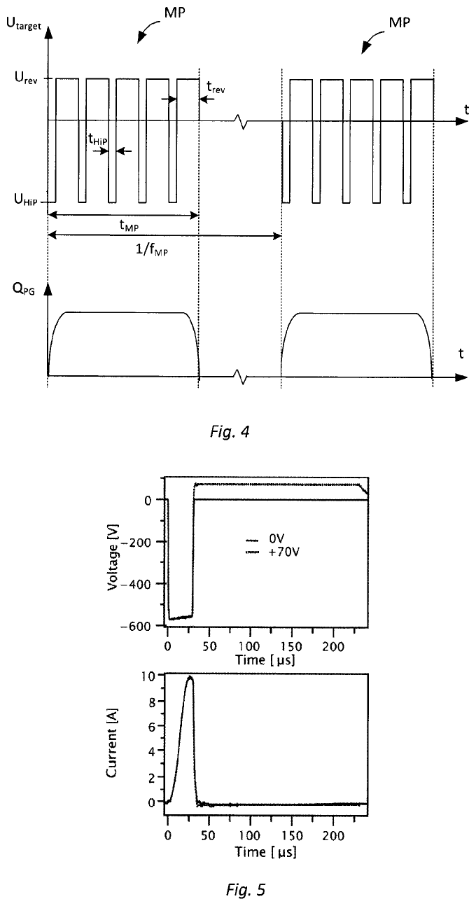

In order to minimise the loss of process gas in neutral form between the pulses, the method according to the present disclosure may comprise correlating the addition of process gas with the pulses. In other words, it is desirable to only supply process gas during the pulses and not during the time between the pulses. At the high peak powers which are desirable for the operation of the ion thruster, it is desirable to use a duty cycle of as low as 1-5%, which means that during 95%-99% of the time, there may be a loss of process gas in case the process gas is supplied continuously. However, it is probably not realistic to supply process gas only during the short duration of the first pulse or even during the duration of a single pulse pair. Therefore, a pulse pattern other than the one shown in FIG. 3 may be advantageous. Such a pulse pattern is illustrated at the top of FIG. 4.

The pulse pattern shown in FIG. 4 comprises a plurality of macro-pulses MP (only two shown in the figure). Each macro-pulse MP is built up of consecutive pulse pairs immediately following each other. Each pulse pair consists of the first pulse, wherein the first electrode is at negative potential (U_{HiP}) with respect to the second electrode, and the second pulse, wherein the first electrode is at positive potential (Uᵣₑᵥ) with respect to the second electrode. In the example shown in the FIG. 4, each macro-pulse comprises five pulse pairs. It is however possible to use another number of pulse pairs for each macro pulse. Each macro-pulse has a duration t_{MP} and the macro-pulses are repeated with a macro-pulse frequency f_{MP}. The pulse pattern illustrated in FIG. 4 enables synchronisation of the pulses with the addition of process gas.

In the pulse pattern shown in FIG. 4, the ranges of the parameters described with regard to the pulse pattern shown in FIG. 3 are also applicable. With regard to the macro-pulse duration t_{MP} and the macro-pulse frequency f_{MP}, these should be chosen so that the target does not risk being damaged by overheating. During the macro-pulses, the discharge power may be so high that the target temperature gradually increases. Therefore, t_{MP} should be chosen to be sufficiently short so the target temperature in the pulse stays below a temperature value at which the material of the target may become damaged. Furthermore, the repetition frequency f_{MP} must be so low that the target cools down sufficiently between macro-pulses. These combined limits of t_{MP} and f_{MP} depend on the ability to cool the target, and may be determined by experimental tests based on the configuration of the ion thruster and the expected environmental conditions during use thereof.

The lower portion of FIG. 4 illustrates the addition of process gas by means of the process gas inlet flow Q_{PG}. As evident from the figure, the addition of process gas is synchronised with the macro-pulses so that process gas is supplied only during the macro-pulses. Thereby, the loss of process gas outside the duty cycle of the discharge can be minimised.

An alternative to the macro-pulses shown above, while still minimising the loss of process gas outside the duty cycle of the discharge, is to use a pulsed process gas supply to steer the active pulse time of the discharges. This is possible if the discharge cannot be sustained without a process gas. In this case, the pulse power can be left running all the time in the form of a continuous train of pulse pairs, each pulse pair comprising the first pulse and the second pulse. The process gas supply is in this scenario used to determine both the discharge duration and the discharge repetition frequency. The macro-pulse parameters t_{MP} and f_{MP} are then replaced by the corresponding process gas pulse parameters, i.e. the duration of the process gas pulses t_{gas} and their repetition frequency f_{gas}.

In case a process gas is used, it is also desired to minimise potential loss of process gas during the first and second pulses. However, the loss of process gas during the pulses can be minimised by accurate control of the current density during the first pulses. At high current densities, process gas atoms may be recycled through a process-gas recycling loop several times before being lost in the exhaust. This further reduces the needed amount of process gas.

As mentioned above, it is also possible to achieve a self-sustained self-sputtering mode of the target in case the target comprises a material with a self-sputter yield above 1. The self-sputter yield generally increases with energy, at least in energy ranges interesting for the ion thruster and the method for providing thrust according to the present disclosure. More specifically, the self-sputter yield for a given target material increases with both the potential U_{HiP} (which accelerates the incident ions towards the target), and the average charge state of the ions (which increases with higher plasma density, i.e. increases with the spatially averaged average current density J_{T}). The mode of operation without addition of process gas with Y_{SS}>1 can therefore, for some materials, be achieved by increasing U_{HiP} and t_{HiP}.

Examples of elements having self-sputtering yield above 1 for bombarding energies up to 1000 eV include Au, Ag, Cu, Al, and Cr (as given for example in Thin Film Processes, eds. J. L. Vossen and W. Kern, Academic Press, New York, 1978, page 199).

Examples self-sputtering yields of different elements may be determined by previously known computer simulation software. Merely for illustrative purposes, examples of self-sputtering yields are given below in Table 1. These examples have been determined using computer simulation software SRIM 2013 (J. F. Ziegler, software SRIM, version 2013.00, http://www.srim.org) using 20 000 ions sputtering with zero degree incident angle and an energy of 500 eV. Furthermore, the self-sputtering yield for Al and Cu were determined in the same way also at 1000 eV as shown in Table 1.

TABLE 1
Examples of self-sputtering yields at an energy of 500 eV
and 1000 eV, respectively.

| | Self-sputtering yield, | Self-sputtering yield, |
|---|---|---|
| Element | Y₅₅, at 500 eV | Y₅₅, at 1000 eV |
| Na | 1.09 | |
| Mg | 1.47 | |
| Al | 1.02 | 1.41 |
| K | 0.81 | |
| Ca | 0.71 | |
| Cr | 1.17 | |
| Mn | 1.93 | |
| Cu | 2.06 | 3.43 |
| Zn | 4.65 | |

The target may also be made of an alloy based on an element having a self-sputtering yield above 1 to enable a self-sputtering mode.

Furthermore, a small addition of a heavier element in the target promotes an increased sputtering-yield of the lighter element, which may enable pushing the self-sputter yield above 1. Thus, the target may be made of an alloy with small admixtures of heavier elements. An alternative to an alloy comprising heavier elements may for example be a target of one element and having purposively selected impurities only in a surface layer thereof. Atoms of these impurities are not efficiently removed and will in general stay in the surface area while the lighter element is sputtered away. This is especially interesting to use for example in case of the first propellant being an element which otherwise would have a self-sputtering yield slightly lower than 1.

When a self-sustained self-sputtering mode is enabled by the selection of the first propellant, the ion thruster may be operated without any addition of process gas while still being able to sustain the plasma and sputter target atoms. As a result of the self-sputtering, the target sputtering during the first pulse discharge is sufficient to supply both ions to the target to maintain the sputtering process per se as well as ions to the exhaust.

In case the ion thruster is operated without addition of process gas, it is necessary to trigger the ignition of the plasma. This may be achieved by a plasma ignition device as also discussed above. The triggering plasma plume of the plasma ignition device is sufficient to initiate sputtering, creating a plasma in front of the target which is self-sustained.

The control device configured to control the power supply arrangement, and optionally further constituent components of the ion thruster, may comprise one or more control units. The responsibility for a specific function or task may optionally be divided between two or more of the control units. The control device may also comprise communication means configured to communicate with a remote control device, for example a remote control device arranged on earth or at a space station. Thereby, the ion thruster may also be controlled remotely, or the operation or status of the ion thruster may be checked, if desired. The control device may further comprise communication means configured to communicate with a control device of the spacecraft, per se, comprising the ion thruster. Said communication means configured to communication with a remote control device or with a control device of the spacecraft may be realized in accordance with any previously known communication means configured for the same purpose, and will therefore not be further discussed in the present disclosure.

The control of various parts and constituent components in the ion thruster may be governed by programmed instructions. These programmed instructions take typically the form of a computer program which, when executed in the control device, causes the control device to effect desired control actions, for example the steps of the method for providing thrust according to the present disclosure. Such programmed instructions may be stored on a computer-readable medium.

The computer program may comprise routines for, during a first pulse, applying a negative voltage to the first electrode by means of the power supply arrangement so that the first electrode is at a first negative potential with respect to the second electrode, the negative potential being of sufficient amplitude to obtain a spatially averaged current density (<J_{T}>ₘₐₓ) over a surface (S_{T}) of the target that is in contact with the magnetic trap zone, the spatially averaged current density being of sufficient magnitude to sustain a plasma whereby atoms are sputtered from the target and at least a portion of the sputtered target atoms are ionised in the plasma. The computer program may further comprise routines for, during a second pulse, following the first pulse, applying a positive voltage to the first electrode by means of the power supply arrangement so that the first electrode is at a second positive potential with respect to the second electrode, thereby electrostatically accelerating ions that leave a volume adjacent to the target. The computer program may further comprise routines for supplying electrons by means of the electron source device so as to neutralise the space charge of the accelerated ions.

The ion thruster and method for providing thrust as described above is not limited to the specific examples and embodiments discussed above. By way of example, the first propellant need not necessarily be in solid form, but may alternatively be partly or fully in liquid form at least during a part of the time of operation of the ion thruster (i.e. at least a part of the time that thrust is provided). This may for example have the advantage of opening up the possibility of refilling propellant in liquid form. Sputtering of liquid targets has been previously demonstrated within the field of thin film deposition, in which case the liquid is held in place by gravity and/or surface tension. Naturally, in the ion thruster according to the present disclosure, the technique for holding the liquid partly or fully constituting the target relies on the principle of surface tension of the liquid.

Moreover, the ion thruster may be supplemented with a so called air breather mode, if desired. This means that if the ion thruster is to be operated in low orbits, collection of gas from the environment to be used as a further propellant (a third propellant) may be utilized.

Furthermore, the design of the ion thruster is not limited to the design shown in FIG. 1. For example, the sputtering magnetron may be of any other previously known design. For example any previously known sputtering magnetron used for example in thin film deposition techniques. Furthermore, the target may have different shapes such as flat conical, cylindrical etc. The magnetic topology may be constructed to optimize the collimation of the ion beam in the exhaust. Furthermore, the magnetic topology may be modified for the purpose of further reduce the risk for a reversed discharge to ignite during the second pulse.

Furthermore, the thruster may be operated in such a mode that the process gas, i.e. the second propellant, constitutes the primary propellant. In such a case, the first propellant may contribute only to a small portion of the trust provided.

Experimental Results

The experiments were carried out using a magnetically-unbalanced (type II) sputtering magnetron mounted in a stainless-steel high-vacuum system with a base pressure of ˜10⁻⁷ Torr (˜10⁻⁵ Pa). The target, the first propellant material was a 50-mm-diameter Ti disk with a thickness of 6 mm. The process was carried out in Ar at a pressure of 5 mTorr (0.6 Pa). The target was connected to a pulsing unit fed by two dc power supplies, one that delivered a negative potential of 570 V for initiating classical HiPIMS pulses and a second one used to apply the positive potential pulses at a voltage from 0 to 150 V. Pulsing was controlled using a synchronization unit operated at a frequency of 700 Hz. The negative pulses were 30 μs in length and immediately followed by 200 μs long positive pulses.

An energy-resolving mass-spectrometer, capable of measuring ion energies up to 100 eV (singly charged ions) was used for the analysis. The spectrometer was facing the device and was located at a distance of 8 cm from the target. Ion energy distribution functions (IEDFs) were obtained for Ti⁺ (48 amu), Ar⁺ (40 amu) and Ti²⁺ ions (48 amu) for applied Uᵣₑᵥ up to 70 V. The spectrometer orifice was electrically grounded during these experiments and the ion energy was scanned from 0 to 100 eV/charge.

Typical discharge voltage U_{D} and discharge current I_{D} waveforms for standard HiPIMS mode and a modified HiPIMS mode where a second reversed pulse is also included are shown in FIG. 5. For both types of discharges, the initial negative ignition voltage was 570 V which decreased slightly to 560 V at the end of the pulse. In the modified HiPIMS mode, the negative pulse was immediately followed by a 200 μs-long reverse positive pulse Uᵣₑᵥ, which in FIG. 5 is 70 V, that initially drive a small negative current.

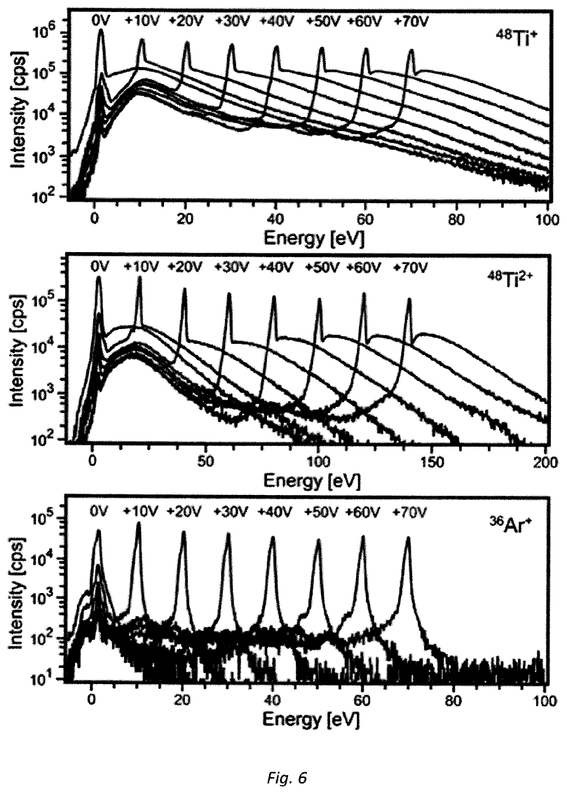

FIG. 6 shows time-integrated IEDF measurements acquired for Ti⁺, Ti²⁺ and Ar⁺ for eight different applied Uᵣₑᵥ ranging from 0 to 70 V, in which Uᵣₑᵥ=0 corresponds to standard HiPIMS and the other curves to the modified HiPIMS. We start by looking at the Ti⁺ flux energy distribution at Uᵣₑᵥ=0, which exhibits a pronounced peak at low energy, ˜3 eV. This is followed by a shoulder at energies up to ˜20 eV and a high-energetic tail. This IEDF, as well as the IEDFs for Ti²⁺ and Ar⁺, are similar to what is generally reported for HiPIMS of metal targets in noble gases. The IEDF curves for the modified HiPIMS have new narrow peaks that appear at an energy which lies slightly above eUᵣₑᵥ.

The integrated intensities of peaks indicate that about half of the Ti⁺ and Ti²⁺ ions are accelerated over the full potential of the reversed pulse. This gives the energy gain eUᵣₑᵥ for singly charged ions, and 2 eUᵣₑᵥ for doubly charged ions.

In the experiments described above, Uᵣₑᵥ was varied in the range 0-70 V, while the other parameters U_{HiP}, t_{HiP}, tᵣₑᵥ and f were kept constant. As previously discussed, these parameters may be altered based on three desired criteria: (i) minimising the number of not accelerated ions, (ii) maximising the speed of the accelerated ions, and (iii) minimising the loss of atoms in not ionised (neutral) form.

An important parameter to consider is the peak discharge current density at the target, J_{Tmax.}, which is obtained by dividing the maximum discharge current with the area of the target.

Minimising the number of not accelerated ions may be achieved by short t_{HiP} and high J_{Tmax}. Short first pulses are achieved by arranging for a fast rise of the current, and by terminating the first pulse as soon as a desired peak current density J_{Tmax} is reached. The coupled processes of ion back-attraction and ion recycling become more important at higher peak power. These processes keep the ions in a “plasma reservoir” close to the target, and therefore reduce the number of ions that are lost during the first pulse.

Furthermore, it may be considered how to maximize the speed in the accelerated ion populations. For reference, ions with zero initial energy, charge state Z, and mass mᵢ which become accelerated over the potential Uᵣₑᵥ get the speed

$${v}_{i} = \sqrt{\frac{2 {ZeU}_{rev}}{{m}_{i}}} \qquad ( 1 )$$

It is clear that, in order to maximize the ion speed, one should maximize the average charge state (Z) and the reverse pulse amplitude Uᵣₑᵥ, and minimize the ion mass. Starting with (Z): The sputtered atoms are more likely to become multiply ionized when they pass through plasmas of higher density nₑ. It is previously known that for a given HiPIMS device, the plasma density as a rule is proportional to the current density J_{T} at the target. Maximizing (Z) therefore gives the same criterion as above: as high a peak current density J_{Tmax} as possible in view of other criteria.

Considering maximizing Uᵣₑᵥ: The only apparent limitation is that, for too high Uᵣₑᵥ, arc breakdown or some other type of reversed-polarity discharge might develop. This should be avoided. In the experiment described above only up to 150 V was tested. However, in a similar setup 850 V has been applied without any breakdown problems. There is no obvious reason why not much higher values should be possible.

Moreover, loss of sputtered target atoms and process gas in neutral form should be minimised for efficient electric propulsion. This may be achieved by a high peak current density J_{Tmax} which reduces the fraction of the sputtered target atoms that may be lost in neutral form. When a process gas is used, the loss of process gas in neutral form between the pulses may be avoided for example by the macro-pulse described above with reference to FIG. 4. Furthermore, the loss of process gas in neutral form during the pulses may be minimised by high peak current density during the first pulses. The, process gas atoms (such as Ar) that are let into the discharge region can be recycles several times before they are lost in the exhaust.

Discharges which need a supply of process gas can be more or less dependent on it. The key parameter is the self-sputtering yield Yₛₛ of the target material. When Yₛₛ is higher, the need for ions of the process gas in the sputtering process is smaller. In order to keep down the waste of process gas, target materials with high Yₛₛ are preferable.

The listing of claims replaces all previous versions of the claims:

1. An ion thruster comprising:
a sputtering magnetron providing a magnetic trap zone;
a target constituting a first electrode and arranged at the sputtering magnetron, the target comprising a first propellant material;
a second electrode arranged in the proximity of the first electrode;
a power supply arrangement configured to provide a potential difference between the first electrode and the second electrode;
an electron source device arranged outside the magnetic trap zone of the sputtering magnetron; and
a control device configured to control the power supply arrangement so that, during a first pulse, the first electrode is at a first negative potential (U_{HiP}) with respect to the second electrode, the first negative potential being of sufficient amplitude to obtain a spatially averaged current density (<J_{T}>ₘₐₓ) over a surface (S_{T}) of the target that is in contact with the magnetic trap zone, the spatially averaged current density being of sufficient magnitude to sustain a plasma causing sputtering of atoms from the target and ionising at least a portion of the sputtered target atoms;
the control device further configured to control the power supply arrangement so that, during a second pulse, following the first pulse, the first electrode is at a second positive potential (Uᵣₑᵥ) with respect to the second electrode, thus elevating the potential in a volume of the plasma adjacent to the target and thereby accelerating ions of sputtered target atoms that leave said volume of the plasma adjacent to the target, thereby providing thrust.

2. The ion thruster according to claim 1, wherein the spatially averaged current density (<J_{T}>ₘₐₓ) is at least 0.5 A/cm².

3. The ion thruster according to claim 1, further comprising-a plasma ignition device.

4. The ion thruster according to claim 1, wherein the electron source device comprises a hollow cathode discharge device or a field emission device.

5. The ion thruster according to claim 1, wherein the first propellant is selected from an element having a self-sputtering yield (Y_{SS}) above 1, or an alloy based on such an element.

6. The ion thruster according to claim 1, wherein the control device is configured to control the power supply arrangement so as to provide a plurality of macro-pulses with a predetermined macro-pulse frequency, each macro-pulse comprising a plurality of consecutive pulse pairs, each pulse pair comprising the first pulse and the second pulse.

7. The ion thruster according to claim 6, further comprising-a process gas supply device configured to supply process gas in the vicinity of the target, and wherein the control device is configured to control the process gas supply device so as to supply process gas in synchronization with the macro-pulses.

8. The ion thruster according to claim 1, further comprising-a process gas supply device, and
wherein the control device is configured to control the power supply arrangement so as to provide a train of pulse pairs, each pulse pair comprising the first pulse and the second pulse,
the control device further configured to control the process gas supply device so as to supply process gas in a pulsed mode for the purpose of controlling an active time of discharges.

9. Method for providing thrust by means of an ion thruster;
the ion thruster comprising:
a sputtering magnetron providing a magnetic trap zone;
a target constituting a first electrode and arranged at the sputtering magnetron, the target comprising a first propellant material;
a second electrode arranged in the proximity of the first electrode;
a power supply arrangement configured to provide a potential difference between the first electrode and the second electrode;
an electron source device arranged outside the magnetic trap zone of the sputtering magnetron; and
a process gas supply device configured to supply gas in the vicinity of the target;
the method comprising the steps of,
during a first pulse, applying a negative voltage to the first electrode by means of the power supply arrangement so that the first electrode is at a first negative potential with respect to the second electrode, the negative potential being of sufficient amplitude to obtain a spatially averaged current density (<J_{T}>ₘₐₓ) over a surface (S_{T}) of the target that is in contact with the magnetic trap zone, the spatially averaged current density being of sufficient magnitude to sustain a plasma whereby atoms are sputtered from the target and at least a portion of the sputtered target atoms are ionised in the plasma;
during a second pulse, following the first pulse, applying a positive voltage to the first electrode by means of the power supply arrangement so that the first electrode is at a second positive potential with respect to the second electrode, thereby electrostatically accelerating ions that leave a volume of the plasma adjacent to the target; and
supplying electrons by means of the electron source device so as to neutralize the space charge of the accelerated ions.

10. The method according to claim 9, wherein the spatially averaged current density (<J_{T}>ₘₐₓ) is at least 0.5 A/cm².

11. The method according to claim 9, further comprising igniting the plasma by means of a plasma ignition device.

12. The method according to claim 9, wherein the first propellant is selected from an element having a self-sputtering yield (Y_{SS}) above 1, or an alloy based on such an element; and wherein the sputtering is performed in a self-sustained self-sputtering mode.

13. The method according to claim 9, further comprising-providing a plurality of macro-pulses with a predetermined macro-pulse frequency by means of the power supply arrangement, each macro-pulse comprising a plurality of consecutive pulse pairs, each pulse pair comprising the first pulse and the second pulse.

14. The method according to claim 13, further comprising-supplying process gas in the vicinity of the target by means of the process gas supply device in synchronization with the macro-pulses.

15. The method according to claim 9, further comprising providing a train of pulse pairs, each pulse pair comprising the first pulse and the second pulse; and controlling the active time of discharges by means of supplying process gas in a pulsed mode by means of the process gas supply device.

16. Computer program comprising program code for causing a control device to perform the method according to claim 9.

17. Computer readable medium instructions which, when executed by a control device, cause the control device to perform the method according to claims 9.

18. Spacecraft comprising an ion thruster according to claim 1.

19. The ion thruster according to claim 3, wherein the plasma ignition device comprises a cathodic arc source or a laser ablation device.

20. The ion thruster according to claim 5, wherein the first propellant is selected from the group consisting of Ag, Al, Au, Cr, Cu, Mg, Mn and Zn or an alloy comprising any one of said elements.

21. The ion thruster according to claim 7, wherein the control device is configured to control the process gas supply device so as to supply process gas only during the duration of the macro-pulse.

22. The method according to claim 10, wherein the spatially averaged current density is equal to or higher than 2 A/cm2.

23. The method according to claim 11, wherein the plasma ignition device comprises a cathodic arc source or a laser ablation device.

24. The method according to claim 11, further comprising supplying process gas only during the duration of the macro-pulses.
